(19) United States
(12) Patent Application Publication
(10) Pub. No.: US 2009/0154934 A1
(43) Pub. Date: Jun. 18, 2009

(54) Optical Transceiver Method and Apparatus

(75) Inventors: Jun Jiang, Lake Zurich, IL (US); John St. Peter, Elburn, IL (US); Aroon Tungare, Winfield, IL (US); Huinan Yu, Kildeer, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/958,779

(22) Filed: Dec. 18, 2007

(51) Int. Cl. H04B 10/00

(52) U.S. Cl. 398/135

(57) ABSTRACT

An optical transceiver (200) can comprise an optical receiver (204), an optical lens (201), and an optical transmitter (210). The optical lens can have a lateral periphery (202) and can be configured and arranged to focus at least some incoming light (203) at the optical receiver. The optical transmitter, in turn, can be disposed within a boundary defined by the lateral periphery of the optical lens and other than in a lateral plane that contains the optical receiver.

### TECHNICAL FIELD

This invention relates generally to optical transceivers.

### BACKGROUND

Optical transceivers of various kinds are known in the art. Such transceivers use light (often non-visible light such as infrared light) to transmit and receive data by modulating the light using a modulation technique of choice. A variety of end-user platforms employ optical transceivers (sometimes to supplement other transmission and reception capabilities) with a growing number of uses being evident.

Unfortunately, efficient and/or high data rate free space optical transmission systems tend to work best when the transmitters and receiver elements for both ends of the communication are fairly well aligned. Achieving such alignment, in turn, can represent a challenge when dealing with mobile equipment such as portable two-way voice and/or data communication devices, remote control devices, multimedia consumption devices, data storage devices, and so forth. Furthermore, optical transceivers tend to be relatively large and hence require a form factor that is ill suited to the needs of a portable, handheld implementing platform.

### BRIEF DESCRIPTION OF THE DRAWINGS

The above needs are at least partially met through provision of the optical transceiver method and apparatus described in the following detailed description, particularly when studied in conjunction with the drawings, wherein:

FIG. 1 comprises a flow diagram as configured in accordance with various embodiments of the invention;

FIG. 2 comprises a side elevational sectioned schematic view as configured in accordance with various embodiments of the invention;

FIG. 3 comprises a top plan schematic view as configured in accordance with various embodiments of the invention;

FIG. 4 comprises a side elevational schematic detail view as configured in accordance with various embodiments of the invention;

FIG. 5 comprises a side elevational schematic detail view as configured in accordance with various embodiments of the invention;

FIG. 6 comprises a side elevational schematic detail view as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an optical transceiver can comprise an optical receiver, an optical lens, and an optical transmitter. The optical lens can have a lateral periphery and can be configured and arranged to focus at least some incoming light at the optical receiver. The optical transmitter, in turn, can be disposed within a boundary defined by the lateral periphery of the optical lens and other than in a lateral plane that contains the optical receiver.

By one approach, the optical lens may comprise a non-imaging optical lens that utilizes at least two of the following optical effects on the lens surface: refraction, reflection, and total internal reflection. If desired, the material comprising the optical lens may purposefully offer a filtering characteristic (using, for example, color).

By one approach, the optical receiver and the optical transmitter may be disposed substantially co-axial with respect to one another and with respect to a focal point axis for the optical lens. The optical transmitter may be disposed, if desired, on a leading surface of the optical lens and may further comprise, as desired, a supplemental lens that is configured and arranged to optically guide light output from the optical transmitter. The optical receiver, in turn, can be disposed in a focal area of the optical lens. This may comprise, for example, immersing the optical receiver within the optical lens or disposing the optical receiver external to a back surface of the optical lens (depending upon the corresponding location of the focal area for a given optical lens).

So configured, those skilled in the art will recognize and appreciate that a highly compact optical transceiver can be provided that will well accommodate the limited space opportunities afforded by many portable handheld devices. These teachings are particularly useful when seeking to achieve a high ratio of aperture diameter to focal length. The optionally co-axial nature of the disposition of the optical transmitter and the optical receiver further aids with respect to achieving satisfactory alignment of the transceiving components and hence contributes greatly to satisfactory operation of the system in a variety of application settings. Those skilled in the art will recognize and appreciate that these teachings therefore yield a compact apparatus that enables bidirectional communication with significantly improved ease of alignment as compared to conventional lateral transceiver configurations and where rotational symmetry is also well accommodated as well.

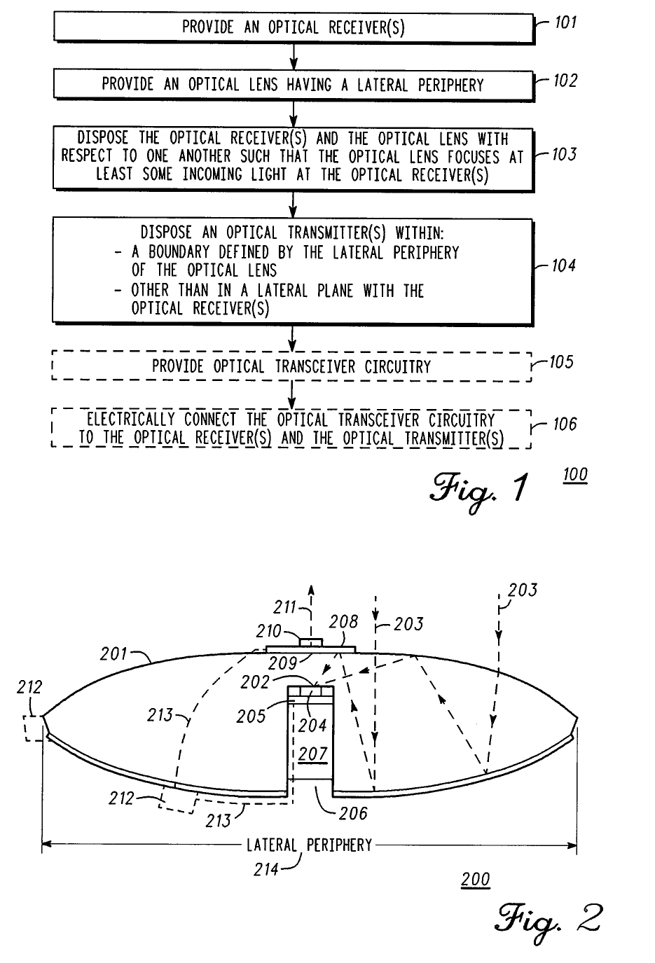

These and other benefits may become clearer upon making a thorough review and study of the following detailed description. Referring now to the drawings, and in particular to FIG. 1, an illustrative process that is compatible with many of these teachings will now be presented.

To begin, and referring as well to FIGS. 2 and 3, this process 100 provides 101 an optical receiver 204. Various optical receivers are known in the art and will suffice for these purposes. By one approach, this optical receiver 204 comprises at least one photodetector (such as, for example, a photodiode, a phototransister, a photomultiplier, an avalanche photodetector (APD), a metal-semiconductor-metal (MSM) photodetector, a p-n photodetector, a p-i-n photodetector, and so forth) component on a corresponding circuit board 205 or other supporting platform. Such a circuit board 205 can include other components (not shown) as desired, including but not limited to amplifiers, signal processing (such as photonic signal processing and electronic signal processing) elements, and the like. Those skilled in the art will understand that such a circuit board 205 can comprise, if desired, a photonic integrated circuit (PIC) and/or an optoelectronic integrated circuit (OEIC) as are known in the art. Those skilled in the art will further recognize that such a circuit board 205 can comprise a single multi-layer board or can be comprised of a plurality of stacked circuit boards (which may comprise one or more daughter boards).

Depending upon the needs and/or opportunities presented by a given application setting, this optical receiver 204 can comprise a plurality of optical receivers. In such a case, each such optical receiver may compatibly receive a same wavelength of light or, if desired, differing wavelengths of light may be received by various of the optical receivers. As but one simple illustrative example in this regard, when the optical receiver 204 comprises two independent optical receivers, one of the independent optical receivers may respond to visible light while the remaining independent optical receiver may respond to infrared light.

As noted, various such optical receivers are known in the art. As these teachings are not overly sensitive to any particular selection in this regard, for the sake of brevity and the preservation of clarity, further elaboration in this regard will not be presented here.

This process 100 then provides for provision 102 of an optical lens 201. This optical lens 201 has a lateral periphery (denoted in FIG. 2 by reference numeral 214) having a relevance that will be made more clear further below. Generally speaking, this optical lens 201 is configured and arranged to focus at least some incoming light at the optical receiver 204. By one approach the optical lens 201 comprises a non-imaging lens as is known in the art that utilizes at least two of the following optical effects on the lens surface: refraction, reflection, and total internal reflection. Accordingly, those skilled in the art will recognize that an RXI type lens will serve for these purposes as well as, for example, an RX type lens or a TIR type lens. Other possibilities may also exist in this regard depending upon, for example, the requirements and/or opportunities as tend to characterize a given application setting.

Such lenses are known in the art, having found application in various unidirectional optical devices. Relevant examples are to be found in an article entitled “Flat High Concentration Devices” by J. C. Minano (which presents an optical receiver) and in U.S. Pat. No. 6,639,733 to Minano et al. (entitled “High Efficiency Non-Imaging Optics” and which presents an optical transmitter), the contents of which are fully incorporated herein by this reference. As such lenses are known in the art, and again for the sake of brevity, further details will not be presented here.

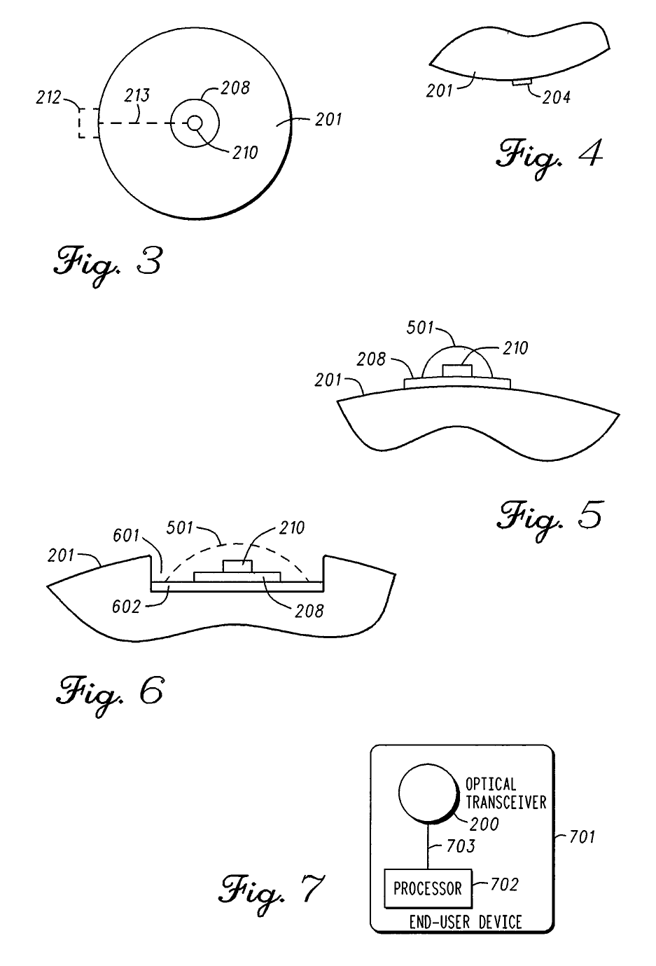

This process 100 then provides for disposing 103 the optical receiver 204 and the optical lens 201 with respect to one another such that the optical lens focuses at least some incoming light 203 at the optical receiver 204. This can comprise, for example, placing the optical receiver 204 in a focal area 202 of the optical lens 201. By one approach, and as shown in FIG. 2, this can comprise immersing the optical receiver 204 within the optical lens 201. This can comprise, for example, placing the optical receiver 204 within a cavity 206 that is appropriately formed in a trailing surface of the optical lens 201 to thereby provide access to the aforementioned focal area 202. By another approach (and where, for example, the focal area lies external to the optical lens 201 along a back surface thereof) and as illustrated in FIG. 4, this can comprise disposing the optical receiver 204 on a back surface of the optical lens 201 to achieve the desired coincidence between the focus area and the optical receiver 204. Other possibilities in this regard may exist as well.

So configured, and referring again to FIG. 2, light 203 entering the front of the optical lens 201 will make its way via reflection and refraction to the focus area 202 and hence to the optical receiver 204. To assist in this regard, at least a portion of the optical lens 201 (such as a central portion on the leading edge of the optical lens, which central portion may, or may not, be substantially planar) can be highly reflective or even mirrored. This, in turn, can greatly improve the ability of the optical receiver 204 to receive a sufficient quantity of signal to facilitate accurate reception and decoding of the corresponding information sent in combination with that optical carrier.

This process 100 then provides for disposing 104 an optical transmitter (which may comprise, for example, a light emitting diode (LED), a Laser Diode (LD), a vertical cavity surface emitting laser (VCSEL), or the like along with corresponding driver electronics as known in the art) both within a boundary that is defined by the previously mentioned lateral periphery 214of the optical lens 201 as well as other than in a lateral plane with the optical receiver 204. Of course, juxtaposing such components other than in a side-by-side configuration runs opposite to ordinary thinking in this regard, but the applicant has determined that such a configuration brings various benefits into play.

As shown in FIGS. 2 and 3, this can comprise placing the light output portion of the optical transmitter 210 on a leading surface of the optical lens 201. The light output portion can be an integral part of the optical transmitter 210 or an extended part that is connected to the optical transmitter 210 by means of an optical fiber/waveguide or lightguide that is configured such that the light output is substantially perpendicular to the leading surface of the optical lens. This can comprise, for example, placing the optical transmitter 210 atop another element 208 that may have a mirrored or otherwise highly reflective undersurface 209 (when, for example the optical lens 201 itself lacks sufficient reflectivity in this regard) such that light beams striking this undersurface 209 will be reflected towards the previously mentioned optical receiver 204. It would also be possible for this element 208 to further comprise a printed circuit board or the like to thereby support other passive and active components (not shown) as may be useful or necessary (in a given embodiment) to facilitate the operation of the optical transmitter 210.

By another approach, if desired, light can be redirected in such an instance by using optical fibers or fiber-like structures. In such a case, only the fiber tip(s) need to be placed on top of the lens surface. Such fibers can comprise a 90 degree bent fiber or a flat fiber with a 45 degree mirrored surface to bend light by 90 degrees

If desired, and as shown in FIG. 3, this element 208 can have a circular shape. It would also be possible to form this element 208, in whole or in part, of an electromagnetic shielding material of choice (such as a cladding or layer (or layers) of solid or mesh conductive metals such as copper, silver, gold, or the like). This, in turn, would result in the disposition of electromagnetic shielding between the optical transmitter 210 and the optical receiver 204 which may be desirable depending upon the technologies used and/or the nature of the application setting.

If desired, it would also be possible to associate the optical transmitter 210 with a supplemental lens. For example, and referring momentarily to FIG. 5, a configuration such as that just described can further comprise a supplemental lens 501 that is configured and arranged (by choice of material as well as geometry) to optically guide light output 211 (FIG. 2) from the optical transmitter 210 and perform beam expansion and shaping to optimize overall power efficiency of the bi-directional application systems.

Other possibilities exist in this regard as well. To illustrate, and referring now to FIG. 6, the leading surface of the optical lens 201 can have a small cavity 601 formed therein. A mirrored surface 602 can be disposed within this cavity 601 (to provide the aforementioned internal reflection of incoming light to the optical receiver 204). The aforementioned element 208, comprising in this example a small circuit board, is then disposed atop the mirrored surface 602 and serves to support the optical transmitter 210. Again, if desired, a supplemental lens 501 can then be disposed over the optical transmitter 210 for the purposes described above.

Just as the optical receiver 204 may comprise a plurality of (identical or dissimilar) optical receivers, the optical transmitter 210 may also comprise a plurality of optical transmitters. By one approach, this comprises a plurality of substantially identical optical transmitters (in that they all transmit light at a substantially identical wavelength). By another approach, one or more of the plurality of optical transmitters can utilize a different wavelength. To illustrate and not by way of intending any limitations in this regard, a first such optical transmitter can comprise a data transmitter that uses, for example, modulated infrared light while a second such optical transmitter can comprise an alignment pointer that outputs visible light. This visible light beam, in turn, can be used by an end user to properly align the optical transceiver 200 with a desired point of interaction by essentially aiming the visible light beam at the intended communication target.

As noted above, the optical transmitter 210 and the optical receiver 204 do not share a common lateral plane. Instead, in this particular illustrated approach, these two components are disposed substantially co-axial to one another and, more particularly, co-axial to the focal point axis for the optical lens 201. Those skilled in the art will note that the described apparatus will serve as a useful optical transceiver notwithstanding that the optical transmitter 210 and the optical receiver 204 can, in fact, be so oriented. This surprising capability permits, in turn, a relatively compact form factor as compared to prior art optical transceivers.

By one approach, the aforementioned circuit boards associated with each of the optical transmitter 210 and the optical receiver 204, respectively, may be provided with a wireless interface to thereby facilitate the exchange of control signaling. For example, a high speed version of Bluetooth technologies can serve in this regard. By another approach, these components can be controlled via a suitable electrical conductor/wire assembly (which might comprise, for example, a shielded conductor if needed to address electromagnetic interference (EMI) issues in a given application setting).

Those skilled in the art will recognize that there are many ways to make such electrical connections (213) from the transmitter and receiver to the processor. Some examples include, but are not limited to, parallel conductor assemblies (similar to ribbon cable or flex circuits) and shielded cables having one or more internal conductors. It is also possible for these electrical connections to be transmission lines designed for the proper impedance if necessary to meet the needs of a given application setting. Generally speaking, for many purposes, the transmitter and receiver will each have a minimum of three connections: signal, supply, and ground.

To illustrate, and referring now again to FIGS. 1, 2, and 3, this process 100 can accommodate providing 105 optical transceiver circuitry 212 of choice and then electrically connecting 106 that optical transceiver circuitry 212 to the optical receiver 204 and/or the optical transmitter 210 using an appropriate electrical conductor 213 such as a copper, silver, gold, or other conductive metal wire or trace. The latter may connect only at its terminal points of connection, or, if desired, can be further coupled along its length to another surface such as an external or internal surface of the optical lens 201.

These configurations will permit other variations as will be well appreciated by those skilled in the art. As one illustrative example in this regard, the previously mentioned optical lens cavity 206 can further serve to receive one or more heatsinks 207 that operably couple to the optical receiver 204 and which are configured and arranged to lead heat away from the optical receiver 204.

This small achievable form factor, coupled as well with the intrinsic ease by which such a transceiver can be suitably aligned with a counterpart, makes this optical transceiver 200 particularly suitable for use in end-user devices of various kinds. To illustrate, and referring now to FIG. 7, this optical transceiver 200 can serve in a variety of end-user devices 701 such as, but not limited to, portable two-way voice communications devices, portable two-way data communications devices, remote control devices, multimedia consumption devices, and data storage devices, to note but a few examples in this regard. In such application settings, for example, the optical transceiver 200 can operably couple (for example, through a serial data interface 703 of choice) to a processor 702. The latter, in turn, can be configured and arranged (via, for example, suitable programming as will be well understood by those skilled in the art) to transmit information and/or to receive information of various kinds using the optical transceiver 200.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An optical transceiver comprising:
an optical receiver;
an optical lens having a lateral periphery and being configured and arranged to focus at least some incoming light at the optical receiver;
an optical transmitter that is disposed within:
a boundary defined by the lateral periphery of the optical lens; and
other than in a lateral plane with the optical receiver.

2. The optical transceiver of claim 1 wherein the optical lens comprises a non-imaging optical lens that utilizes at least two of the following optical effects on the lens surface: refraction, reflection, and total internal reflection.

3. The optical transceiver of claim 1 wherein the optical receiver and the optical transmitter are disposed substantially co-axial to one another.

4. The optical transceiver of claim 3 wherein the optical lens has a focal point axis, and wherein the optical receiver and the optical transmitter are disposed substantially co-axial to the focal point axis.

5. The optical transceiver of claim 1 wherein the optical receiver is placed in a focal area of the optical lens.

6. The optical transceiver of claim 5 wherein the optical transmitter is disposed on a leading surface of the optical lens.

7. The optical transceiver of claim 5 wherein the optical receiver is placed in a focal area of the optical lens by one of:
immersing the optical receiver within the optical lens; and
disposing the optical receiver external to a back surface of the optical lens.

8. The optical transceiver of claim 1 wherein the optical transmitter comprises a plurality of optical transmitters.

9. The optical transceiver of claim 8 wherein at least one of the plurality of optical transmitters comprises a data transmitter and wherein at least one of the plurality of optical transmitters comprises an alignment pointer that outputs visible light.

10. The optical transceiver of claim 1 further comprising:
a supplemental lens configured and arranged to optically guide light output from the optical transmitter.

11. The optical transceiver of claim 1 further comprising:
electromagnetic shielding disposed between the optical transmitter and the optical receiver.

12. The optical transceiver of claim 1 further comprising:
an optical filter configured and arranged to filter at least some light passing through the optical lens.

13. The optical transceiver of claim 11 wherein the optical filter comprises a filtering characteristic of the optical lens itself.

14. The optical transceiver of claim 1 further comprising:
at least one heat sink that operably couples to the optical receiver and which is configured and arranged to lead heat away from the optical receiver.

15. The optical transceiver of claim 1 further comprising:
an end-user device that integrally houses the optical receiver, the optical lens, and the optical transmitter, wherein the end-user device further comprises a processor that connects to at least the optical receiver through a serial data interface.

16. The optical transceiver of claim 15 wherein the end-user device comprises at least one of a portable two-way voice communications device, a remote control device, a multimedia consumption device, a data storage device, and a two-way data communications device.

17. The optical transceiver of claim 1 further comprising:
a main control circuit board that operably couples to the optical transmitter and the optical receiver via shielded electrical connections, wherein the main control circuit board is disposed on at least one of:
a side surface of the optical lens; and
a back surface of the optical lens.

18. A method of facilitating the formation of an optical transceiver, comprising:
providing an optical receiver;
providing an optical lens having a lateral periphery;
disposing the optical receiver and the optical lens with respect to one another such that the optical lens focuses at least some incoming light at the optical receiver;
disposing an optical transmitter within:
a boundary defined by the lateral periphery of the optical lens; and
other than in a lateral plane with the optical receiver.

19. The method of claim 18 wherein disposing an optical transmitter comprises disposing the optical transmitter on a leading surface of the optical lens.

20. The method of claim 18 wherein disposing the optical receiver comprises disposing the optical receiver within a cavity formed in a trailing surface of the optical lens.

21. The method of claim 18 further comprising:
providing optical transceiver circuitry;
electrically connecting the optical transceiver circuitry to the optical receiver and the optical transmitter.
